(19) United States
(12) Patent Application Publication
(10) Pub. No.: US 2015/0040010 A1
(43) Pub. Date: Feb. 5, 2015

(54) USER INTERFACE FOR DEPICTIVE VIDEO EDITING

(71) Applicant: THOMSON LICENSING, Issy de Moulineaux (FR)

(72) Inventors: Anton Werner Keller, Arni (CH); Severin Werner Engeli, Herisan (CH)

(21) Appl. No.: 14/378,450

(22) PCT Filed: Feb. 15, 2012
(86) PCT No.: PCT/IB2012/000270

§ 371 Date: Aug. 13, 2014

(51) Int. Cl. G06F 3/0484; G06F 3/0482; G06F 3/0485

(52) U.S. Cl. CPC G06F 3/04842; G06F 3/0485; G06F 3/0482
USPC 715/723

(57) ABSTRACT

A flexible hose user interface is used to promote sophisticated editing of video sequences in an easy manner. The flexible hose allows a user to visualize the effects of cropping on a frame by frame basis. A time axis action identifier aids the user in checking if desired objects are in all frames of the sequence. This is accomplished easily by dragging the time axis identifier through the flexible hose.

### BACKGROUND

Based on modern 1920×1080 (or more) video cameras, video cropping has become popular. Lesser resolutions (e.g., DVD 720×576) are still satisfactory and a video-picture contains exactly the perspective needed. Different sophisticated video editing software like “Sony Vegas Pro” and “Corel MediaStudio Pro” allow variable cropping, rotating and other manipulation of video streams. However, these parameters may change over a sequence by an input of the user. Those parameters are usually entered by displaying a video sequence consisting of several sub-sequences with key-frames that mark the beginning or end of those sub-sequences (BEGIN key-frame and END key-frame). Then the parameters can be chosen in a dialog-box. The system of the dialog-boxes is very basic, technically oriented and requires a lot of input-actions and is not very depictive.

### SUMMARY

Video editing systems and methods are provided that incorporates a novel way to input video cropping and rotation, despite changing parameters. The user-interface has a 3-dimensional look and feel effect that allows very simple operation. A flexible hose concept is introduced that allows positioning of objects within a video frame to be followed as the video sequence progresses. In this manner, a user can easily visualize what cropping, etc. needs to be accomplished to provide coverage of desired objections.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 shows a 3-dimensional view of a video sequence with several key-frames.

FIG. 2 shows a movie sequence to be edited.

FIGS. 3a to 3f depict the editing of an adaptive cropping.

FIG. 4 depicts a choice of editing transition effects.

FIG. 5 shows a representation of a frame including action identifiers.

FIG. 6 is a flow diagram of a method of editing video sequences.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

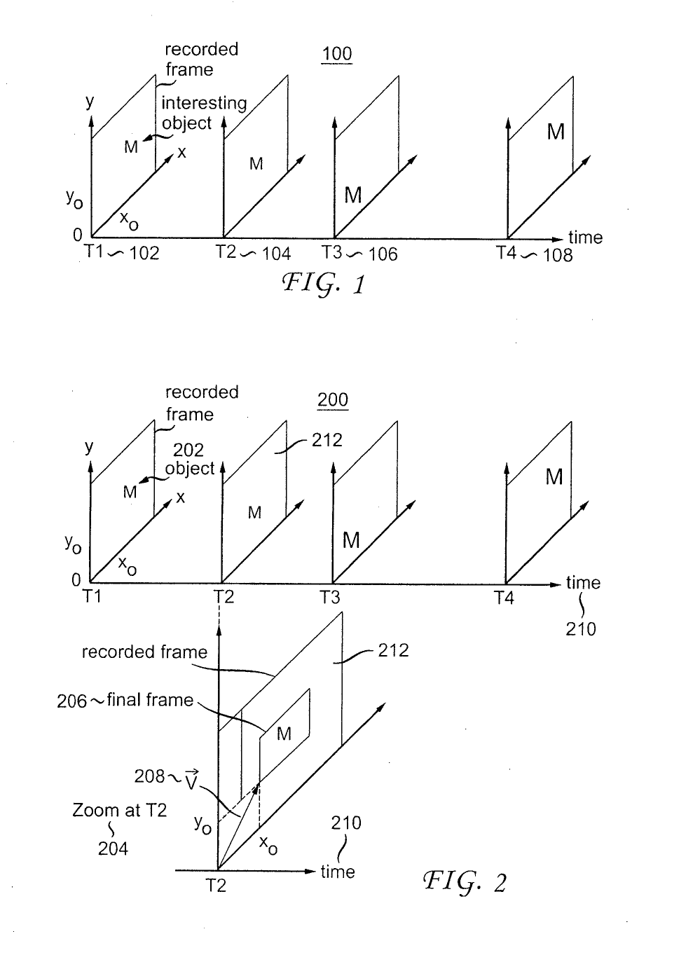

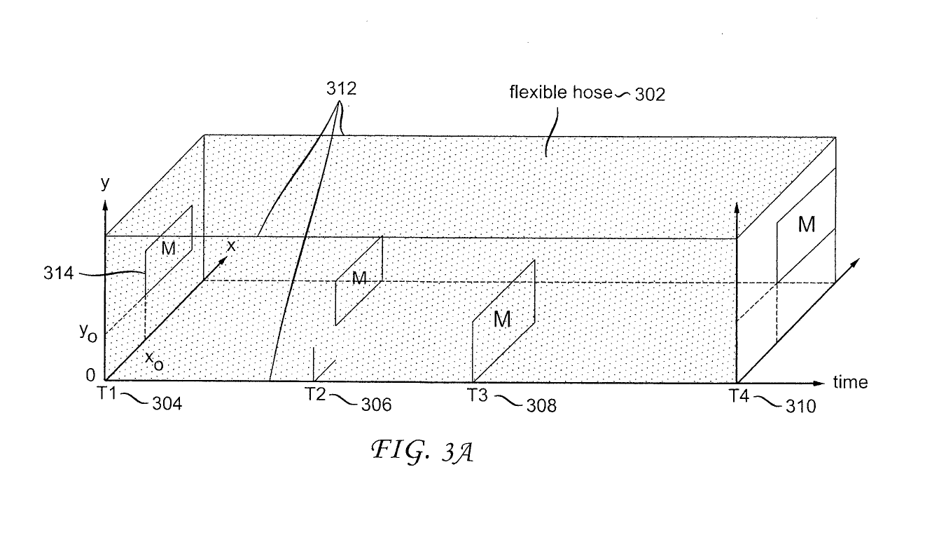

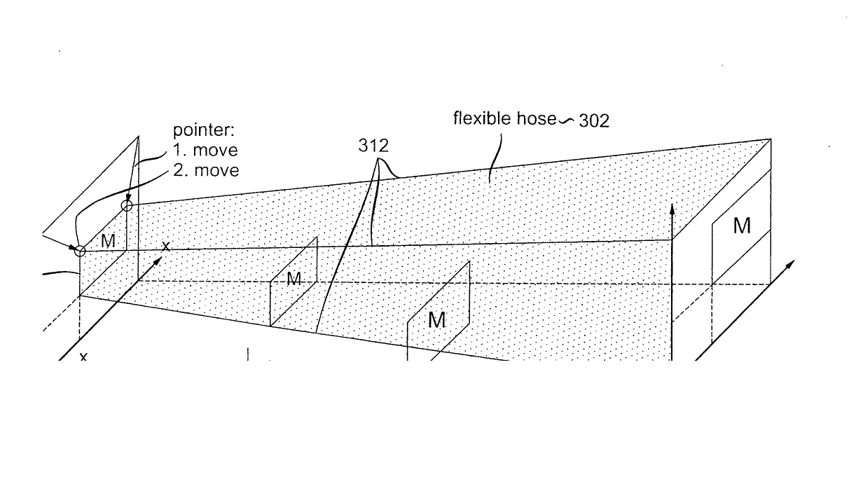

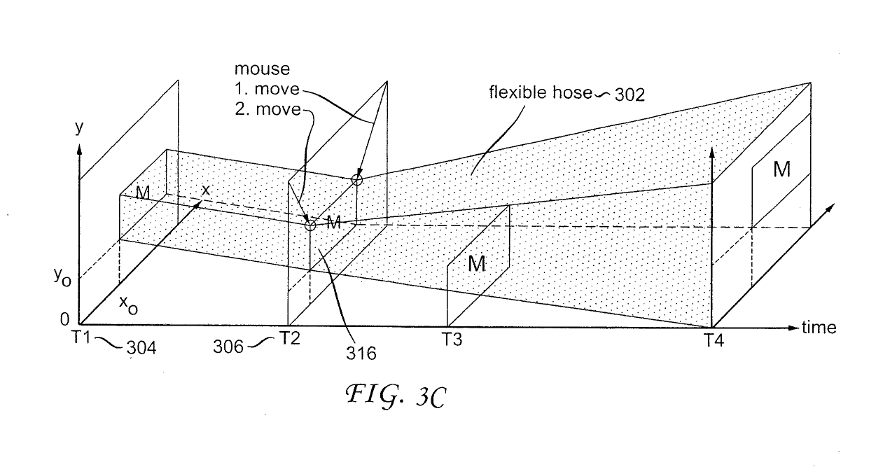

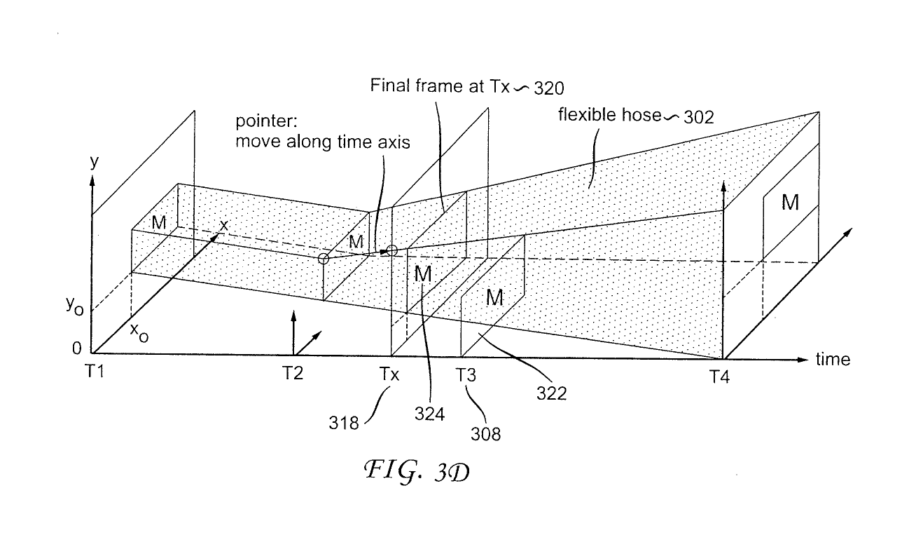

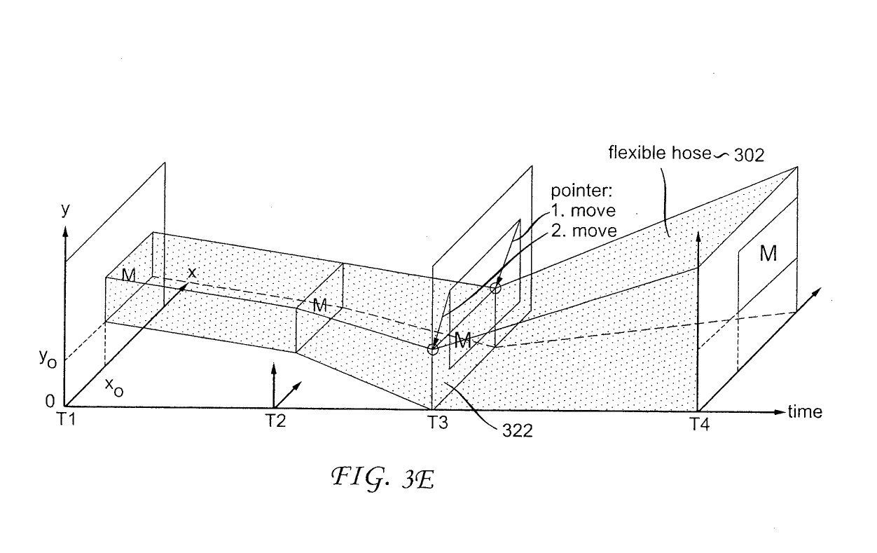

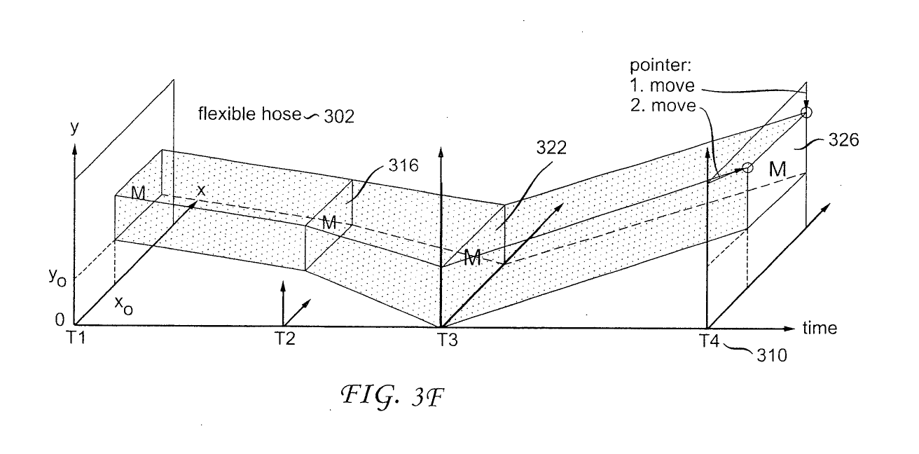

Video editing solutions are provided that include a novel way to input video cropping and rotation. Video frames can be rotated, magnified (zoomed in) and/or resized according to user input (e.g., cropping). FIG. 1 shows a 3-dimensional view 100 of a video sequence with several key-frames 102-108 at the times T1, T2, T3, T4. The 3-D view 100 gives a good overview about the whole video sequence. For implementation, certain terms are defined as follows: A “recorded frame” is the frame with the high input resolution. A “final frame” is the frame used in the final video. It will be resized to the output format (depicted in FIG. 3 and further). The central object is marked with the letter “M.” This object is not always in an optimized position of a video (frame) which is supposed to become its final position by cropping, etc.

With previous solutions, the user was forced to define the key-frames (T1, T2, T3, T4) where a transition of the cropping-function takes place. Then the user gets a respective 2-dimensional view and defines the cropping of this frame. Different input-boxes help to define all the necessary parameters. However, this user-interface is a not a very depictive representation of the video to be edited.

With depictive solutions, it is advantageous to have a 3-dimensional (spatial) timeline of the video. FIG. 2 shows a movie sequence 200 to be edited. The object of importance is marked by the letter “M” 202. In the zoomed part 204 at T2 a possible final frame 206 (after the editing) and, optionally, its vector of origin 208 is/are displayed for better understanding by the user. In some instances, the vector of origin 208 is not shown to the user. When a mouse pointer is moved along the time axis 210 the respective frame 212 is displayed either in the time line and/or in an additional window.

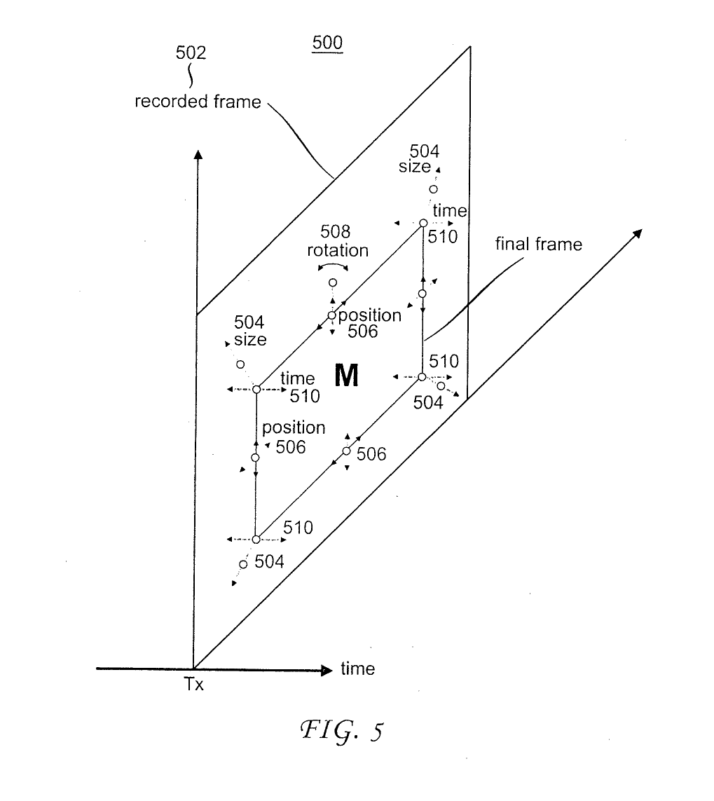

The FIGS. 3a to 3f depict the editing of an adaptive cropping. A flexible hose 302 depicts the used 3-dimensional video space (x, y and time) in a spatially visualized way. The interpolation of the flexible hose between two given frames is selectable among linear, logarithmic, spline etc. For this example, the interpolation is set to linear. For a better understanding of all the final frames at T1, T2, T3 and T4 304-310 (after the editing) are displayed in all figures. This example illustrates cropping only. Further editing behavior like rotation and filtering are described later in relation to FIG. 5.

In FIG. 3a, we can see the un-cropped video in a 3-dimensional view.

A flexible hose 302 (dotted mantle) encases the video containing all the frames. The edges 312 of the flexible hose 302 behave like rubber-bands. The flexible hose 302 is dragged (by the edges 312) to fit the final frame 314 of T1 304 by, for example, a pointing device as illustrated in FIG. 3b.

After resizing the frame in T1 304, the pointing device is moved to the frame in T2 306. Again the flexible hose 302 is dragged until the final frame 316 fits the object M in T2 306. The shape of the flexible hose 302 is adapted between T1 and T2 and between T2 and T4 in a linear manner as shown in FIG. 3c. Alternatively, other interpolation can be employed as well.

FIG. 3d shows the behavior when the pointing device runs along the flexible hose 302 (in the time axis). The respective picture at Tx 318 is displayed in a 3-D view and the user can check if the final frame 320 contains all desired objects. In this case, the user moves further to T3 308 and decides to set a new final frame 322 (size and position) because the object 324 has moved to the lower edge. Again the flexible hose 302 is adapted to fit the new final frame 322 as depicted in FIG. 3e.

The user then moves the pointing device to T4 310 and fixes the final frame 326 like-wise and the flexible hose 302 shows the 3-D space used by the final frames 316, 322, 326 as shown in FIG. 3f. Now the user can run the pointing device along the flexible hose 302 and check if all final frames are satisfactory. The respective frames appear at the pointers position (representing a time). Wherever additional cropping is required, the user makes a selection with the pointing device and adjusts the flexible hose 302.

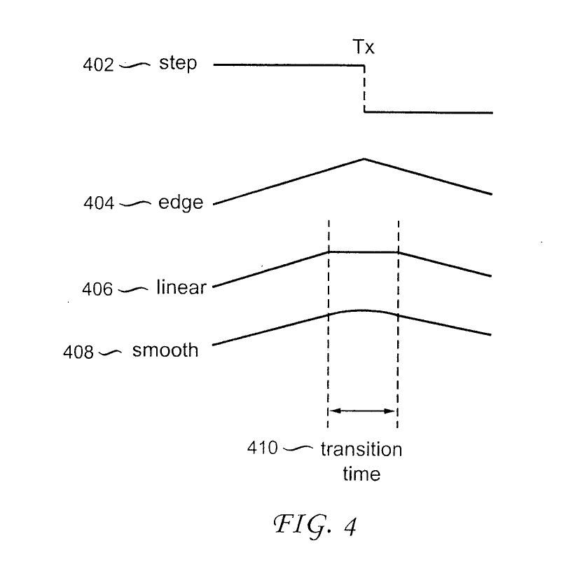

To complete the editing of the variable cropping (zoom), the user can choose different transitions 402-408 of the flexible hose in the exact times T1-T4. FIG. 4 depicts a choice of effects. The step effect 402 demands a second final frame. One final frame for the left side or the step and one for the right side. The edge transition 404 was used for the above examples and a linear 406 and/or a smooth transition 408 adds a special note to the transitions. A transition time 410 can vary depending on the user's desire.

FIG. 5 shows a representation 500 of a frame 502 including action identifiers 504-510. When a pointing device is near one of those identifiers 504-510, they appear and the action is actuated by selecting with the pointing device and moving the pointing device in a desired direction. By utilizing the flexible hose solutions, an action-identifier is provided for a time (x-coordinate) that allows scrolling through the frames. The following action identifiers are illustrated:

“Size” 504 the final frame can be resized, the proportion stays constant.

“Position” 506 the final frame is moved in that frame-plain at time Tx without changing the size.

“Rotation” 508 allows a rotation of the actual final frame. That means that the flexible house gets a twist in between two frames with different rotation.

“Time” 510—when grabbing this corner and moving horizontally along the time-axis, Tx changes. It is like browsing through the video scrolling all the frames. Other commands can be utilized as well. For example, using the scroll-wheel for the size of the frame (zoom) and/or using a right mouse button for certain action, etc. Alternatively, a keyboard can be used for the inputs. The left-right arrow keys can be used to move through the time axis. Up and down keys can be used to resize a final frame, etc. The arrow keys together with a shift key can be used to move the final frame. After the complete editing of the video, the movie is rendered in the new format and the viewer will see only the frames within the flexible hose.

This user interface is more depletive and more flexible than previous solutions. It helps the user to edit a movie in a more easy (but sophisticated) way. The flexible hose (also “flexible-zoom-hose” or “flexible-crop-hose”) gives the user a strong aspect and understanding of the movie editing. The display of the actual frame . at the pointer position—in a 3-Dimensional style—allows a quick review of the editing to be done or done.

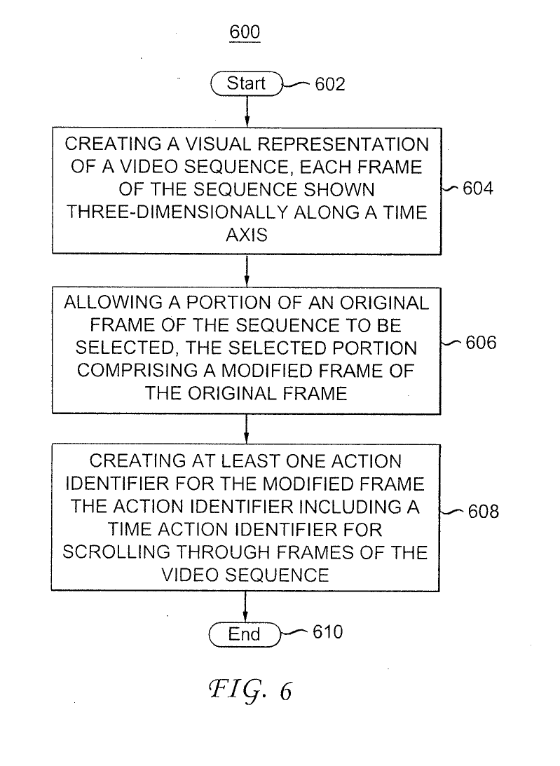

In view of the exemplary systems shown and described above, methodologies that can be implemented in accordance with the embodiments will be better appreciated with reference to the flow charts of FIG. 6. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 6 is a flow diagram of a method 600 of editing video sequences. The method starts 602 by creating a visual representation of a video sequence, each frame of the sequence shown three-dimensionally along a time axis 604. A portion of an original frame of the sequence is then selected, the selected portion comprising a modified frame of the original frame 606. At least one action identifier is created for the modified frame, the action identifier including a time action identifier for scrolling through frames of the video sequence 608, ending the flow 610. The action identifier can also include at least one of a size action identifier, a position action identifier and a rotation action identifier. The linking frames of the video sequence along a time axis can be accomplished to form a visual representation of the frame edits. At least one video sequence frame is allowed to be edited by selecting and moving at least one of the links forming the visual representation. This creates the “flexible hose” that allows users to manipulate edits throughout the timeline of the video sequence. The transitions formed by the links (flexible hose joints at each frame of the video sequence) is selectable from at least one of a step transition, an edge transition, a linear transition and a smooth transition.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A user interface that permits editing of video sequences, comprising:
a visual representation of a video sequence wherein at least one editable frame of the sequence are shown three-dimensionally along a time axis;
a portion of an original frame of the sequence that is selectable, the selectable portion comprising a modified frame of the original frame; and
at least one action identifier for the modified frame, the action identifier including a time action identifier for scrolling through frames of the video sequence.

2. The system of claim 1, wherein the action identifier can also include at least one of a size action identifier, a position action identifier and a rotation action identifier.

3. The system of claim 1, further comprising:
links between frames of the video sequence along a time axis to form a visual representation of selected portions of frames.

4. The system of claim 2, wherein at least one link of at least one video sequence frame is movable.

5. The system of claim 4, wherein a transition formed at each frame of the sequence by the links is selected from at least one of a step transition, an edge transition, a linear transition and a smooth transition.

6. A method for editing video, comprising:
creating a visual representation of a video sequence with editable frames of the sequence shown three-dimensionally along a time axis;
allowing a portion of an original frame of the sequence to be selected, the selected portion comprising a modified frame of the original frame; and
creating at least one action identifier for the modified frame, the action identifier including a time action identifier for scrolling through frames of the video sequence.

7. The method of claim 6, wherein the action identifier can also include at least one of a size action identifier, a position action identifier and a rotation action identifier.

8. The method of claim 6 further comprising:
linking frames of the video sequence along a time axis to form a visual representation of frame edits.

9. The method of claim 8 further comprising:
allowing at least one video sequence frame to be edited by selecting and moving at least one of the links forming the visual representation.

10. The method of claim 8, further comprising:
allowing a transition formed by the links to be selectable from at least one of a step transition, an edge transition, a linear transition and a smooth transition.

11. A system that edits video sequences, comprising:
a means for creating a visual representation of a video sequence with editable frames of the sequence shown three-dimensionally along a time axis;
a means for allowing a portion of an original frame of the sequence to be selected, the selected portion comprising a modified frame of the original frame; and
a means for creating at least one action identifier for the modified frame, the action identifier including a time action identifier for scrolling through frames of the video sequence.

12. The system of claim 11 further comprising:
a means for linking frames of the video sequence along a time axis to form a visual representation of frame edits; and
a means for allowing at least one video sequence frame to be edited by selecting and moving at least one of the links forming the visual representation.
